(19) United States
(12) Patent Application Publication
(10) Pub. No.: US 2026/0371211 A1
(43) Pub. Date: Nov. 19, 2026

(54) Configuration of LTM Candidates using Reference Configuration

(71) Applicant: Telefonaktiebolaget LM Ericsson (publ), Stockholm (SE)

(72) Inventors: Pontus Wallentin, Linköping (SE); Icaro Leonardo Da Silva, Solna (SE); Ioanna Pappa, Stockholm (SE); Antonino Orsino, Kirkkonummi (FI); Cecilia Eklöf, Täby (SE)

(21) Appl. No.: 19/146,683

(22) PCT Filed: Jan. 29, 2024
(86) PCT No.: PCT/SE2024/050072

§ 371 Date: Jul. 9, 2025

(30) Foreign Application Priority Data
Feb. 8, 2023 (GR) 20230100099

(51) Int. Cl. H04W 36/36; H04W 36/00; H04W 36/04

(52) U.S. Cl. CPC H04W 36/36; H04W 36/0061; H04W 36/04

(57) ABSTRACT

For LTM mobility, the UE is pre-configured with an RRC configuration per candidate cell for L1/L2 inter-cell mobility. A serving network node requests one or more network nodes that are potential targets for a cell switch to create corresponding candidate cell configurations. In some embodiment, the request may indicate a reference configuration, which may be the UE's current configuration, to use to create the candidate cell configuration. After receiving the candidate cell configuration, the serving network node sends a configuration message to the UE to configure the UE with the candidate cell configurations. The reconfiguration message includes, for each of one or more candidate cells, the candidate cell configuration received from the network node for the candidate cell and a reference configuration. The candidate configuration of one or more candidate cells includes an indication to not use the reference configuration to determine the target cell configuration. The first and second indications collectively provide instruction to the UE how to generate a target cell configuration for a LTM cell switch.

### TECHNICAL FIELD

The present disclosure relates generally to inter-cell mobility in wireless communication networks and, more particularly, to techniques for reducing latency of inter-cell mobility events.

### BACKGROUND

A work item for Release 18 of the Third Generation Partnership Project (3GPP) standards for the New Radio (NR) interface in Fifth Generation (5G) networks, known as “Further NR mobility enhancements”, includes enhancements for support of Layer1 (L1)/Layer 2 (L2) based inter-cell mobility, also referred to as L1/L2-triggered mobility (LTM). According to the Work Item Description (WID), when a user equipment (UE) in a wireless communication network moves from the coverage area of one cell to another cell, a serving cell change needs to be performed to maintain continuity of service. Conventionally, inter-cell mobility is handled by the Radio Resource Control (RRC) layer, also known as Layer 3 (L3). The UE sends measurement reports to the serving cell including measurements for the serving cell and neighboring cells. Based on the measurement reports and possibly other information, the base station for the serving cell decides when a cell change is needed and triggers a change of the Primary Cell (PCell) or Primary Secondary Cell (PSCell) by sending a RRC reconfiguration message. The reconfiguration may also add or remove a secondary cell (SCell) when the PCell is changed. The reconfiguration messages to the UE indicates a target cell and contains information needed by the UE to access the target cell. The current procedure results in a complete Layer 1 (L1) and Layer 2 (L2) resets, leading to longer latency, larger overhead and longer interruption time compared to beam switch mobility.

The objective of the work item is to specify support for LTM for latency reduction. A basic principle of LTM is that the UE is pre-configured by the network with an RRC configuration per LTM candidate cell, sometimes also known as a LTM candidate cell configuration. The LTM candidate cell configuration may be an RRCReconfiguration message or one or more information elements (IEs)/fields/parameters such as CellGroupConfig. The UE performs measurements on these LTM candidate cells and transmits corresponding measurement reports to the network. The network then triggers the execution of a LTM cell switch procedure in the UE to one of these LTM candidate cells by transmitting an LTM cell switch command via L1/L2 signaling (e.g., via a Medium Access Control (MAC) Control Element (MAC-CE)) to the UE. In response to the cell switch command, the UE connects to the particular LTM candidate cell and switches to an RRC configuration of this LTM candidate cell.

Many details of the procedures for L1/L2-based inter-cell mobility are still open in 3GPP. L1/L2 mobility needs to support LTM candidate cell configurations that are delta configurations relative to a reference configuration, which can be managed separately from the LTM candidate cell configuration. The LTM candidate cell configurations should be modified and released only by the network. Within these constraints, procedures are needed to add, modify, and release LTM configurations. Further, procedures are needed to manage the LTM configuration separately from the refence configurations.

### SUMMARY

The present disclosure relates to methods for signaling a RRC configuration for LTM events. The UE is pre-configured with an RRC configuration per candidate cell for L1/L2 inter-cell mobility. A serving network node requests one or more network nodes that are potential targets for a cell switch to create corresponding candidate cell configurations. In some embodiment, the request may indicate a reference configuration, which may be the UE's current configuration, to use to create the candidate cell configuration. After receiving the candidate cell configuration, the serving network node sends a configuration message to the UE to configure the UE with the candidate cell configuration. The reconfiguration message includes, for each of one or more candidate cells, a first indication of the candidate cell configuration received from the candidate target network node and a second indication of a reference configuration. In other embodiments, the indication of the reference configuration may be sent in a separate reconfiguration message. The first and second indications collectively provide instruction to the UE how to generate a target cell configuration for a LTM cell switch. Different alternatives are provided for what the indication of an LTM candidate cell reference configuration indicates.

The proposed solution enables the network to use reference configurations when configuring a UE with target configurations for LTM candidate cells. This reduces the amount of signaling between the network and the UE when transmitting the target configurations. It also simplifies the handling in the network to determine delta configuration, as it is clearer what the baseline configuration is.

A first aspect of the disclosure comprises methods of L1/L2-based inter-cell mobility implemented by a user equipment (UE). In one embodiment, the method comprises receiving a reference configuration to be used for determining a target cell configuration. The method further comprises receiving a candidate cell configuration for each of one or more candidate cells, wherein one or more candidate cell configurations include an indication to not use the reference configuration. The method further comprises performing a cell switch to a target cell selected from the candidate cells. The method further comprises determining a target cell configuration for the target cell based on the candidate cell configuration associated with the target cell and the presence or absence of the indication to not use the reference configuration.

A second aspect of the disclosure comprises a UE configured to operate in a wireless communication network implementing L1/L2-based inter-cell mobility. In one embodiment, the UE is configured to receive a reference configuration to be used for determining a target cell configuration. The UE is further configured to receive a candidate cell configuration for each of one or more candidate cells, wherein one or more candidate cell configurations include an indication to not use the reference configuration. The UE is further configured to perform a cell switch to a target cell selected from the candidate cells. The UE is further configured to determine a target cell configuration for the target cell based on the candidate cell configuration associated with the target cell and the presence or absence of the indication to not use the reference configuration.

A third aspect of the disclosure comprises a UE configured to operate in a wireless communication network implementing L1/L2-based inter-cell mobility. In one embodiment, the UE comprises communication circuitry for communicating with a network node and processing circuitry. The processing circuitry is configured to receive a reference configuration to be used for determining a target cell configuration. The processing circuitry is further configured to receive a candidate cell configuration for each of one or more candidate cells, wherein one or more candidate cell configurations include an indication to not use the reference configuration. The processing circuitry is further configured to perform a cell switch to a target cell selected from the candidate cells. The processing circuitry is further configured to determine a target cell configuration for the target cell based on the candidate cell configuration associated with the target cell and the presence or absence of the indication to not use the reference configuration.

A fourth aspect of the disclosure comprises a computer program for a UE configured to operate in a wireless communication network implementing in a wireless communication network implementing L1/L2-based inter-cell mobility. The computer program comprises executable instructions that, when executed by processing circuitry in a UE, causes the UE to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

A sixth aspect of the disclosure comprises methods implemented by a network node in a wireless communication network implementing L1/L2-based inter-cell mobility. In one embodiment, the method comprises sending, to a target network node for a candidate cell for the UE, a request to create a candidate cell configuration for the candidate cell, the request including a reference configuration. The method further comprises determining a target cell configuration for the target cell based on the candidate cell configuration associated with the target cell and the presence or absence of the indication to not use the reference configuration.

A seventh aspect of the disclosure comprises a network node in a wireless communication network implementing L1/L2-based inter-cell mobility. In one embodiment, the network node is configured to send, to a target network node for a candidate cell for the UE, a request to create a candidate cell configuration for the candidate cell, the request including a reference configuration. The network node is further configured to receive, from the target network node, the candidate cell configuration created using the reference configuration.

An eighth aspect of the disclosure comprises a c in a wireless communication network implementing L1/L2-based inter-cell mobility. In one embodiment, the UE comprises communication circuitry for communicating with a network node and processing circuitry. The processing circuitry is configured to send, to a target network node for a candidate cell for the UE, a request to create a candidate cell configuration for the candidate cell, the request including a reference configuration. The processing circuitry is further configured to receive, from the target network node, the candidate cell configuration created using the reference configuration.

A ninth aspect of the disclosure comprises a computer program for a network node system in a wireless communication network implementing L1/L2-based inter-cell mobility. The computer program comprises executable instructions that, when executed by processing circuitry in a network node, causes the network node to perform the method according to the sixth aspect.

A tenth aspect of the disclosure comprises a carrier containing a computer program according to the ninth aspect. The carrier is one of an electronic signal, optical signal, radio signal, or a non-transitory computer readable storage medium.

### BRIEF DESCRIPTION OF THE DRAWINGS

FIG. 1 illustrates an exemplary wireless communication network implementing inter-cell mobility.

FIG. 2 is a signaling flow illustrating configuration of a UE for L1/L2-based mobility in a distributed RAN architecture when no reference configuration exists at configuration of the candidate cell configuration and the candidate cell configuration becomes the reference configuration.

FIG. 3 is a signaling flow illustrating configuration of a UE for L1/L2-based mobility in a distributed RAN architecture when no reference configuration exists at configuration of the candidate cell configuration and the candidate configuration is created based on a current UE configuration in the source cell.

FIG. 4 is a signaling flow illustrating configuration of a UE for L1/L2-based mobility in a distributed RAN architecture when a reference configuration exists and the candidate cell provides a delta configuration.

FIG. 5 is a signaling flow illustrating configuration of a UE for L1/L2-based mobility in a distributed RAN architecture when a reference configuration exists and the candidate cell provides a full configuration.

FIG. 6 is a signaling flow for a L1/L2-based mobility procedure.

FIG. 7 illustrates a method of L1/L2-based mobility implemented by a UE.

FIG. 8 illustrates a method of L1/L2-based mobility implemented by a UE.

FIG. 9 illustrates a method of L1/L2-based mobility implemented by a source network node.

FIG. 10 illustrates a method of L1/L2-based mobility implemented by a target network node.

FIG. 11 illustrates a method of L1/L2-based mobility implemented by a serving network.

FIG. 12 illustrates a method of L1/L2-based mobility implemented by a UE.

FIG. 13 illustrates a method of L1/L2-based mobility implemented by a serving network node.

FIG. 14A illustrates an exemplary UE configured for L1/L2-based mobility according to an embodiment.

FIG. 14B illustrates an exemplary network for supporting L1/L2-based mobility according to an embodiment.

FIG. 15 shows an example of a communication system in accordance with some embodiments.

FIG. 16 is a block diagram of a host in accordance with various aspects described herein.

FIG. 17 shows a communication diagram of a host communicating via a network node with a UE over a partially wireless connection in accordance with some embodiments.

### DETAILED DESCRIPTION

For L1/L2-based mobility, the UE is pre-configured with an RRC configuration per candidate cell for L1/L2 inter-cell mobility. A serving network node requests one or more network nodes that are potential targets for a cell switch to create corresponding candidate cell configurations. In some embodiment, the request may indicate a reference configuration, which may be the UE's current configuration, to use to create the candidate cell configuration. After receiving the candidate cell configuration, the serving network node sends a configuration message to the UE to configure the UE with the candidate cell configuration. The reconfiguration message includes, for each of one or more candidate cells, a first indication of the candidate cell configuration received from the candidate target network node and a second indication of a reference configuration. In other embodiments, the indication of the reference configuration may be sent in a separate reconfiguration message. The first and second indications collectively provide instruction to the UE how to generate a target cell configuration for a LTM cell switch.

In some embodiments, the UE may be configured with a Master Cell Group (MCG) and a Secondary Cell Group (SCG). The serving cell can be a Primary Cell (PCell) in the MCG, a Primary SCG Cell (PSCell), or a Secondary Cell (SCell in either the MCG or SCG.

The inter-cell mobility techniques are described herein in the context of a Fifth Generation (5G) network using the New Radio (NR) air interface. Those skilled in the art will appreciate that the techniques are more generally applicable to networks based on other standards, including long term Evolution (LTE) networks and other wireless networks designed for UE mobility.

The term “L1/L2 based inter-cell mobility” has the meaning given in 3GPP and refers to a mobility procedure where the UE performs a cell switch or cell change (e.g., change of a PCell, from a source PCell to a target PCell) responsive to lower layer signaling (L1 or L2 signaling) from the network. The term “L1/L2 based inter-cell mobility” is used interchangeably with the terms L1/L2 mobility, L1 mobility, L1-based mobility, L1/L2-centric inter-cell mobility, L1/L2 inter-cell mobility L1/L2-triggered Mobility, lower-layer triggered mobility, and LTM. The lower layer signal triggering the cell switch is referred to herein interchangeably as a L1/L2 inter-cell mobility execution command or LTM cell switch command.

The term “LTM cell switch procedure” refers to a procedure for switching a UE from a source cell to a target cell, which may be referred to herein as a LTM candidate cell or a neighbor cell, using LTM. In the context of LTM, an LTM cell switch procedure may sometimes also be known as L1/L2-based inter-cell mobility execution, LTM execution, dynamic switch, LTM switch, LTM cell switch, LTM serving cell change, or LTM cell change.

In the context of LTM, upon switching to the LTM candidate cell, the UE considers the LTM candidate cell to be its new special cell (SpCell). The SpCell could be a PCell in the case of LTM being configured for a Master Cell Group (MCG) and/or PSCell in the case of LTM being configured for a Secondary Cell Group (SCG). In some embodiments, the UE changes its SpCell from the current PCell to an indicated LTM candidate cell. The cell switch or cell change may comprise a switch or change of a whole cell group configuration, which includes a change in the SpCell (e.g., change of PCell, or change of PSCell) and a change in SCells of the cell group (e.g., addition, modification and/or release of one or more SCells).

The text refers to a LTM candidate cell, which is a cell the UE is configured with when configured with L1/L2-triggered mobility. That is a cell the UE can move to in a LTM cell switch procedure, upon reception of a LTM cell switch command. Such cells may also be called candidate cell(s), candidates, mobility candidates, non-serving cells, additional cells, candidate cell, target candidate, etc. A LTM candidate cell is a cell the UE may perform measurements on (e.g. CSI measurements) so that the UE reports these measurements and network may take educated decision on which beam (e.g. TCI state) and/or cell the UE is to be switched to. An LTM candidate cell may be a candidate to be a target PCell or PSCell, or an SCell of a cell group (e.g. MCG SCell or a SCG SCell).

The disclosure refers to at least one configured LTM candidate cell and that the UE has received at least one LTM candidate cell configuration. This is also sometimes referred to as a configuration of a LTM candidate cell, which may be an RRC configuration. The RRC configuration may be encapsulated in an RRC Reconfiguration message received when the UE is being configured for LTM. A configuration of a LTM candidate cell comprises the configuration that the UE needs to operate when it performs an LTM cell switch procedure to that LTM candidate cell, e.g., upon reception of the LTM cell switch command indicating that the LTM candidate cell is the target cell and the current (new) SpCell, or an SCell in a serving frequency. The configuration of a LTM candidate cell comprises parameters of a serving cell (or multiple serving cells, such as a cell group). The parameters may comprise one or more of the groups of parameters, such as an RRCReconfiguration message, an IE CellGroupConfig, or an IE SpCellConfig (or the IE SCellConfig, in the case of a Secondary Cell). A configuration of a LTM candidate cell may, in one example, comprise one or more of: i) the PCell configuration and one or more SCell configuration(s) of a Master Cell Group (MCG); i) the PSCell configuration and one or more SCell configuration(s) of a secondary Cell Group (SCG). The terms LTM candidate configuration, LTM configuration, (LTM) candidate cell configuration, (LTM) target candidate (cell) configuration may be used interchangeably when referring to configuration of a LTM candidate cell.

The actual LTM candidate cell configuration and its exact content and/or structure of this IE and/or embedded message may be called an RRC model for the candidate configuration, or simply RRC model. An LTM candidate cell configuration comprises the configuration which the UE needs to operate accordingly when it performs (executes) L1/L2 based inter-cell mobility execution to that LTM candidate cell, upon reception of the lower layer signaling indicating a L1/L2 based inter-cell mobility to that LTM candidate cell. The LTM candidate cell becomes the target cell and the current (new) PCell, or an SCell in a serving frequency. The UE may be configured with multiple LTM candidate cells, so a candidate distributed unit (DU) generates and sends to the centralized unit (CU) multiple configuration(s). The actual LTM candidate cell configuration the UE receives during the LTM configuration may be a delta configuration to be applied on top of a reference configuration, so that the actual configuration the UE is to use in the candidate cell upon LTM cell switch is the combination of the LTM candidate cell configuration and the reference configuration (e.g., separately signaled by the network to the UE.

The term “beam” may correspond to a spatial direction in which a signal is transmitted (e.g., by a network node) or received (e.g., by the UE), or a spatial filter applied to a signal which is transmitted or received. Thus, transmitting signals in different beams corresponds to transmitting signals in different spatial directions. The term “selected beam” as used herein refers to a beam index and/or a reference signal (RS) index or identifier, such as a Synchronization Signal Block (SSB) index, or a Channel Sate Information Reference signal (CSI-RS) resource identifier. Thus, selecting a beam may correspond to selecting an SSB associated with an SSB index, or selecting a CSI-RS associated with a CSI-RS resource identifier.

The solutions described for “LTM candidate cell” may be equally applicable for conditional reconfigurations such as Conditional PSCell Change (CPC), Conditional PSCell Addition (CPA), or Conditional Handover (CHO). When the term “LTM candidate cell” is used, it may refer to a target candidate PSCell for CPC, CPA, or a target candidate PCell for CHO. When the term “LTM configuration” corresponds in CPC/CPA/CHO to the UE receiving a ConditionalReconfiguration IE and storing the information, including an RRCReconfiguration message. The LTM cell switch procedure used in LTM is the effective equivalent of a trigger condition being fulfilled for CPC/CPA/CHO and the UE performing conditional reconfiguration execution, including applying a stored RRCReconfiguration message.

The change of serving cell (e.g. change of PCell) may also lead to a change in Scell(s) for the same cell group, e.g., in case the command triggers the UE to change to another cell group configuration of the same type (e.g. another MCG configuration). Before the UE receives the LTM cell switch command, the UE is configured by the network with one or more LTM candidate cells (e.g. reception of an RRC Reconfiguration message, with at least one LTM candidate cell configuration) A candidate cell configuration may include parameters in the IE CellGroupConfig per LTM candidate cell and/or an embedded RRC Reconfiguration per LTM candidate cell.

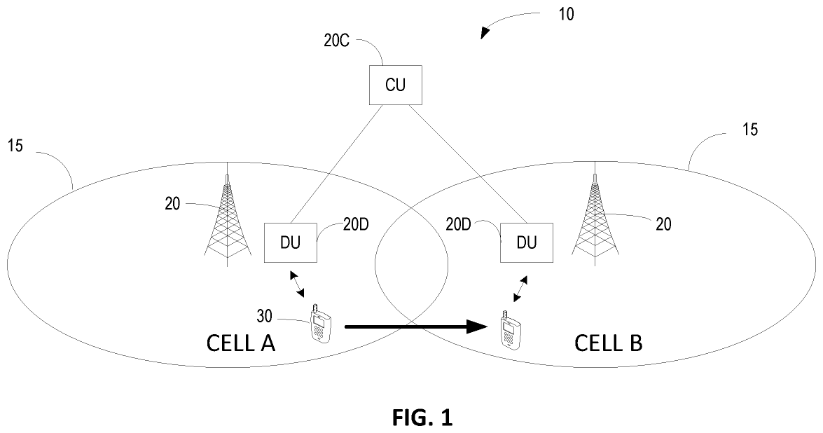

FIG. 1 illustrates a model of a wireless communication network 10 according to the NR standard currently being developed by Third Generation Partnership Project (3GPP). The wireless communication network 10 comprises one or more base stations 20 providing service to user equipment (UEs) 30 in respective cells 15 of the wireless communication network 10. The base stations 20 are also referred to as a 5G NodeB (gNB) in the 5G standards. The base stations 20 may be partitioned into a distributed unit (DU) 20D that performs some of the lower layer functions of the protocol stack and a centralized unit (CU) 20C that performs higher layer functions of the protocol stack. In some embodiments, the RRC layer is located in the CU and the Medium Access Control (MAC) and/or Physical layer (PHY) is located in the DU. The CU functions may be implemented as a container or virtual machine executed by a commercial off the shelf (COTS) hardware in a datacenter.

The UEs 30 may comprise any type of equipment capable of communicating with the base station 100 over a wireless communication channel. For example, the UEs 30 may comprise cellular telephones, smart phones, laptop computers, notebook computers, tablets, machine-to-machine (M2M) devices (also known as machine type communication (MTC) devices), embedded devices, wireless sensors, or other types of wireless end user devices capable of communicating over wireless communication networks 10.

In the example shown in FIG. 1, the UE 30 is located in Cell A and is moving toward Cell B. Cell A is the current serving cell. Cell B is the target cell. The term source network node may refer to the base station, including the DU-CU, in the serving cell, or to the DU in the serving cell. The term target network node may refer to the base station, including the DU-CU in the target cell, or to the DU in the target cell. The source network node and the target network node may be the same network node in some embodiments.

In a conditional reconfiguration procedure, a source network node may be a source Secondary Node (SN) serving a source PSCell, or a source Master Node (MN) serving a source PCell. A target network node may be a target Secondary Node (SN) serving a target PSCell or a target Master Node (MN) serving a target PCell. The interface between the network nodes in case of conditional reconfigurations is Xn instead of F1.

In some embodiments, the source network node and target network node communicate with a third network node referred to herein as a serving network node. The serving network node may comprise CU in a distributed radio access network (RAN) architecture, or a core network node. In the case of a distributed RAN architecture, the serving network node may be a user plane CU (CU-UP), or a control plane CU (CU-CP). The serving network node in this case is also referred to as a serving CU, a gNB-CU-UP, and a gNB-CU-UP. The core network node may be a User Plane Function (UPF), or an access and Mobility Management Function (AMF).

In embodiments of the present disclosure, L1/L2-based signaling is used to reduce latency following a serving cell change. The UE 30 sends measurement reports (e.g., at predetermined intervals) to the serving cell including measurements for the serving cell and neighboring cells. Based on the measurement report and possibly other information, the base station for the serving cell decides when a cell change is needed and triggers the cell change by sending a LTM cell switch command indicating a target cell and containing information needed by the UE 30 to access the target cell.

For LTM mobility, the UE 30 is pre-configured with an RRC configuration per candidate cell for L1/L2 inter-cell mobility. The candidate target configurations can be configured by radio resource control signaling, such as a RRCReconfiguration message, a CellGroupConfig, and/or ServingCellConfig (or equivalent), and/or ServingCellConfigCommon.

Each RRC configuration for LTM is associated with a cell identifier, such as a Physical Cell Identifier (PCI), and/or a pointer to a cell identifier, so that the UE 30 may later receive lower layer signaling from the network indicating the cell identifier (or similar, such as a Transmission Configuration Indicator (TCI) state and/or beam identifier associated to that cell). The lower layer signaling may comprise a Medium Access Control (MAC) Control Element (MAC-CE) or Downlink Control Information (DCI) indicating one of the configured candidate cells. Upon reception of that lower layer signaling, the UE 30 can execute the LTM procedure without further RRC signaling to change to a new serving cell (e.g., change of PCell), which requires the UE 30 to apply the stored RRC configuration for LTM of the target cell. Applying in this context could mean switching to the indicated configuration, activating the configuration, or operating accordingly.

In embodiments of the present disclosure, the serving network node requests one or more network nodes that are potential targets for a cell switch to create corresponding candidate cell configurations. This request may be contained in a UE 30 Context Setup Request. In some embodiment, the request may indicate a reference configuration to use to create the candidate cell configuration. The reference configuration may comprise a current UE 30 configuration used by the UE 30 in a source cell. Responsive to the request, the target network node returns the candidate cell configuration to the serving network node, e.g., in a UE 30 Context Setup Response. After receiving the candidate cell configuration, the serving network node sends a configuration message to the UE 30 to configure the UE 30 with the candidate cell configuration. The reconfiguration message includes, for each of one or more candidate cells, a first indication of the candidate cell configuration received from the candidate target network node and a second indication of a reference configuration. In other embodiments, the indication of the reference configuration may be sent in a separate reconfiguration message. The first and second indications collectively provide instruction to the UE 30 how to generate a target cell configuration for a LTM cell switch.

In a distributed radio access network (RAN) architecture, the DU for the target network node receives a request from a CU to create a candidate cell configuration for L1/L2 inter-cell mobility. The request may include a reference configuration (e.g., the RRC parameters, fields, IEs), which may be the UE's current configuration for the UE's current serving cell (e.g., PCell). The DU for the target network node generates a candidate cell configuration to be applied (or switched to) by the UE 30 based on the UE's current configuration for the PCell and returns the candidate cell configuration to the CU. The CU sends a RRC reconfiguration message to the UE 30 to configure LTM mobility. The RRC Configuration message includes, for each of one or more candidate cells, a first indication of the candidate cell configuration received from the candidate target network node and a second indication of a reference configuration. In other embodiments, the indication of the reference configuration may be sent in a separate reconfiguration message. The first and second indications collectively provide instruction to the UE 30 how to generate a target cell configuration for a LTM cell switch.

The candidate cell configuration for some or all of the candidate cells may comprise a full RRC configuration and the second indication for such candidate cells indicates that no reference signal is used to create the target cell configuration, or alternatively to use the candidate cell configuration as the target cell configuration.

In some embodiments, the candidate cell configuration for some or all of the candidate cells comprises a delta configuration (e.g., IEs, fields, parameters, etc.) to be combined with a reference configuration identified by the second indication. In this case, the candidate cell configuration indicates changes to the reference configuration. In some embodiments, the reference configuration may comprise a full configuration, such as the UE's current configuration or another configuration.

In some embodiments, the reference configuration may be a partial configuration that is combined with the candidate cell configuration. In this case, the reference configuration indicates a first part (i.e., first subset of IEs, fields, parameters, etc.) of the target cell configuration and the candidate cell configuration comprises a second part (i.e., second subset of IEs, fields, parameters, etc.) of the target cell configuration. The candidate cell configuration is generated by combining the IEs, fields, parameters indicated by the reference configuration and the candidate cell configuration. Where the first and second parts overlap, the candidate cell configuration may take precedence over the reference cell configuration.

In some embodiments, the reference cell configuration and candidate cell configuration are applied sequentially to the current UE 30 configuration used by the UE 30 in the source cell. The UE 30 first applies the reference cell configuration on top of the current UE 30 configuration and then applies the candidate cell configuration. The candidate cell configuration may change IEs, fields, parameters, etc. changed by the reference configuration.

Different approaches may be taken as to when the UE 30 determines the target cell configuration. In some embodiments, the stores the candidate cell configuration and the second indication. In this case, the UE 30 determines the reference configuration, if any, after receiving the LTM cell switch command and generates the target cell configuration.

In other embodiments, the UE 30 determines the reference configuration and stores it prior to the LTM cell switch command. In this case, the UE 30 generates the target cell configuration by applying the candidate cell configuration responsive to the LTM cell switch command, and applies the target cell configuration.

In still other embodiments, the UE 30 determines the target cell configuration corresponding to a candidate cell prior to the LTM cell switch command and stores the target cell configuration. In this case, the UE 30 applies the stored target cell configuration responsive to receipt of the LTM cell switch command.

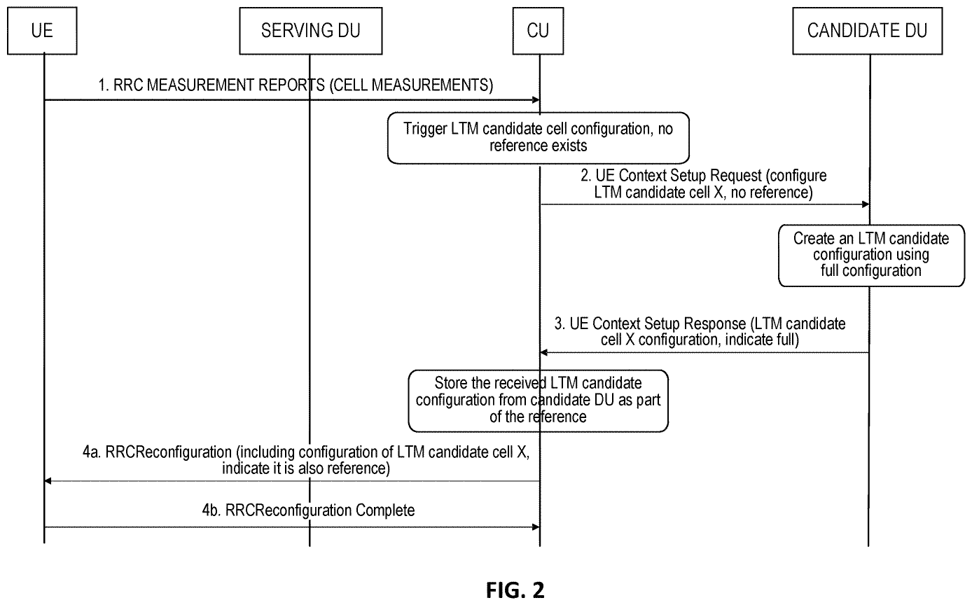

FIG. 2 illustrates signaling flow for configuring the UE 30 for an LTM cell switch in a distributed RAN architecture where no reference configuration exists at the time the CU 20C initiates the LTM configuration. In this example, the LTM candidate cell configuration becomes the LTM candidate cell reference configuration.

In Step 1, the CU 20C receives measurement reports from the UE and determines to configure LTM for an LTM candidate cell associated with a candidate DU. In this example, the CU 20C determines that there is no reference configuration.

In Step 2 the CU 20C transmits the request for the LTM candidate cell to the candidate DU 20D associated with the LTM candidate cell. The request message includes an indication of a reference configuration, which indicates that there is no LTM candidate cell reference configuration. In one example the CU 20C transmits the request in the UE 30 Context Setup Request message.

In Step 3, the candidate DU 20D accepts the request, generates a RRC configuration for the LTM candidate cell (e.g., a container including an RRC Reconfiguration or an IE CellGroupConfig), including a serving cell configuration for the LTM candidate cell. Because the received request indicated that there is no LTM candidate cell reference configuration, the LTM candidate cell configuration generated by the candidate DU 20D is a full RRC configuration, i.e., does not use a delta configuration. The RRC configuration message includes an indication to save the LTM configuration as a reference configuration. In one example the candidate DU 20D transmits the RRC configuration to the CU 20C in the UE 30 Context Setup Response message.

In Step 4a, the CU 20C stores the received LTM candidate cell configuration as the current LTM candidate cell reference configuration. The CU 20C transmits to the UE 30 an RRC reconfiguration message including the LTM configuration for an LTM candidate cell. The reconfiguration message indicates that the LTM candidate cell reference configuration is the LTM candidate cell configuration that is received in the same reconfiguration message. In Step 4b, the UE 30 stores the received LTM candidate cell configuration, considers it to also be the LTM candidate cell reference configuration and returns an RRC Reconfiguration Complete message to the CU.

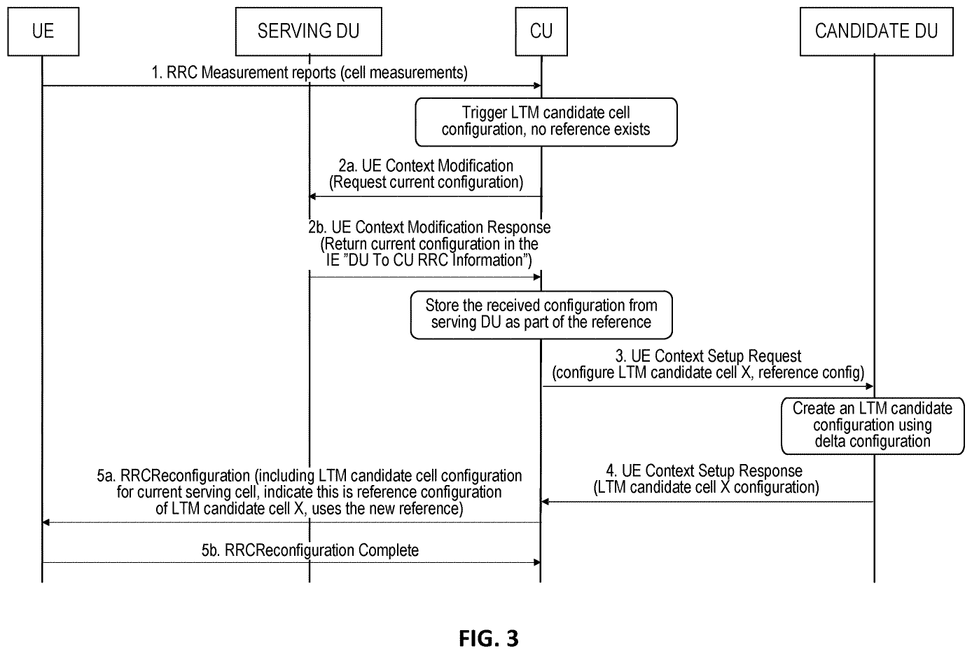

FIG. 3 illustrates a signaling flow for configuring the UE 30 for an LTM cell switch in a distributed RAN architecture where no reference configuration exists at the time the CU 20C initiates the LTM configuration. In this example, the LTM candidate cell creates a delta configuration based on the UE's current configuration, which becomes the reference configuration.

In Step 1, the CU 20C receives a measurement report of the UE 30 and determines to configure LTM for an LTM candidate cell associated with a candidate DU. In this example, the CU 20C determines that there is no reference configuration.

In Step 2a, the CU 20C transmits a request to the serving DU 20D to retrieve the UE's current configuration. In one example, the CU 20C transmits the request in the UE 30 Context Modification Request message. In Step 2b, the serving DU 20D returns the UE's current configuration in a response transmitted to the CU. In one example the CU 20C transmits the configuration in the UE 30 Context Modification Response message.

In Step 3, the CU 20C transmits the request for the LTM candidate cell to the Candidate DU 20D associated to the LTM candidate cell and includes the UE's current configuration as the LTM candidate cell reference configuration. In one example, the request is transmitted in a UE 30 Context Setup Request.

In Step 4, the candidate DU 20D accepts the request and generates an RRC configuration for the LTM candidate cell (e.g., a container including an RRC Reconfiguration or an IE CellGroupConfig), including a serving cell configuration for the LTM candidate cell. The LTM candidate cell configuration uses delta configuration on top of the received LTM candidate cell reference configuration, which is indicated in the message. The candidate DU 20D returns the LTM candidate cell configuration to the CU. In one example, the candidate DU 20D transmits the LTM candidate cell configuration to the CU 20C in a UE 30 Context Setup Response.

In Step 5a, the CU 20C transmits to the UE 30 an RRC Reconfiguration message including the LTM candidate cell configuration. The reconfiguration message indicates that the UE's current configuration is the LTM candidate cell reference configuration. In this example, it is also indicated that the LTM candidate cell configuration uses delta configuration on top of LTM candidate cell reference configuration. In Step 5b, the UE 30 stores the received LTM candidate cell configuration and returns an RRC Reconfiguration Complete message to the CU. Alternatively, the UE 30 may pre-compute the full RRC configuration for the candidate cell using its current configuration as a reference configuration and store the full configuration.

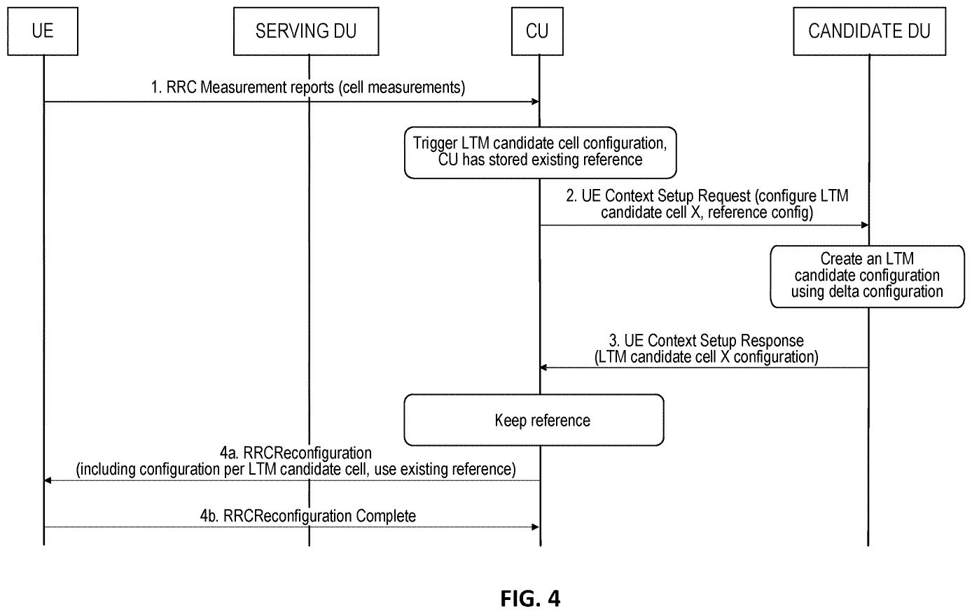

FIG. 4 illustrates an example signaling flow for configuring the UE 30 for an LTM cell switch in a distributed RAN architecture where a reference configuration exists at the time the CU 20C initiates the LTM configuration. In this example, the LTM candidate cell uses delta configuration based on the existing reference configuration.

In Step 1, the CU 20C receives a measurement report from the UE 30 and determines to configure LTM for an LTM candidate cell associated to with a candidate DU 20D. In this example, the CU 20C determines that there is a LTM candidate cell reference configuration known (e.g., stored) by the CU.

In Step 2, the CU 20C transmits the request for the LTM candidate cell to the candidate DU 20D associated with the LTM candidate cell. The request message includes an indication of the LTM candidate cell reference configuration. In one example, the CU 20C transmits the request to the candidate DU 20D in the UE 30 Context Setup Request message.

In Step 3, the candidate DU 20D accepts the request and generates an RRC configuration for the LTM candidate cell (e.g., a container including an RRC Reconfiguration or an IE CellGroupConfig), including a serving cell configuration for the LTM candidate cell. The LTM candidate cell configuration indicates it is a delta configuration based on the reference configuration. In one example the candidate DU 20D returns the RRC configuration in the UE 30 Context Setup Response message. The CU saves the LTM candidate cell configuration.

In Step 4a, the CU 20C transmits to the UE 30 an RRC Reconfiguration message including the LTM configuration for the LTM candidate cell and an indication to use the known reference configuration. The LTM candidate cell configuration indicates it is a delta configuration based on the reference configuration. In Step 4b, the UE 30 stores the received LTM candidate cell configuration and returns an RRC Reconfiguration Complete message to the CU. Alternatively, the UE 30 may pre-compute the full RRC configuration for the candidate cell and store the full configuration.

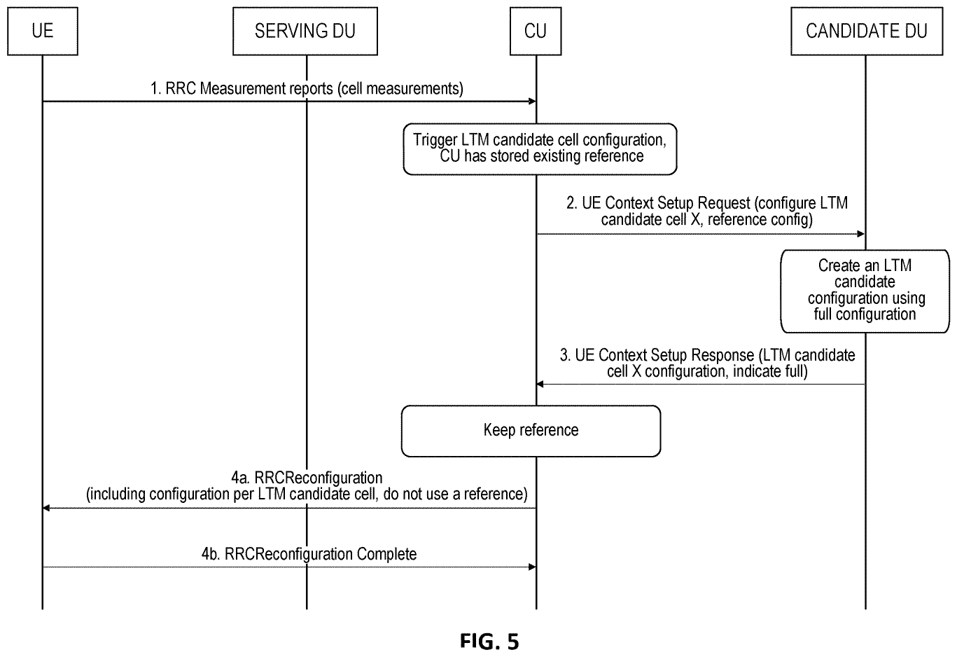

FIG. 5 illustrates another example signaling flow for configuring the UE 30 for an LTM cell switch in a distributed RAN architecture where a reference configuration exists at the time the CU 20C initiates the LTM configuration. In this example, the LTM candidate cell creates full RRC configuration based on the existing reference configuration.

In Step 1, the CU 20C receives a measurement report from the UE 30 and determines to configure LTM for an LTM candidate cell associated to a candidate DU 20D. In this example, the CU 20C determines that there is a LTM candidate cell reference configuration known (e.g., stored) by the CU.

In Step 2, the CU 20C transmits the request for the LTM candidate cell to the candidate DU 20D associated to the LTM candidate cell. The request message includes an indication of the LTM candidate cell reference configuration. In one example, the CU 20C transmits the request to the candidate DU 20D in the UE 30 Context Setup Request message.

In Step 3, the candidate DU 20D accepts the request and generates an RRC configuration for the LTM candidate cell (e.g., a container including an RRC Reconfiguration or an IE CellGroupConfig), including a serving cell configuration for the LTM candidate cell. In this example, the candidate DU 20D determines to use full configuration for the LTM candidate cell configuration instead of delta configuration. Therefore, the LTM candidate cell configuration indicates it uses full configuration. In one example the candidate DU 20D returns the RRC configuration to the CU 20C in the UE 30 Context Setup Response message.

In Step 4a, the CU 20C transmits to the UE 30 an RRC reconfiguration message including the LTM candidate cell configuration. The LTM candidate cell configuration indicates it uses full configuration. The RRC reconfiguration message includes an indication to not use a reference configuration. In Step 4b, the UE 30 stores the received LTM candidate cell configuration and returns an RRC Reconfiguration Complete message to the CU.

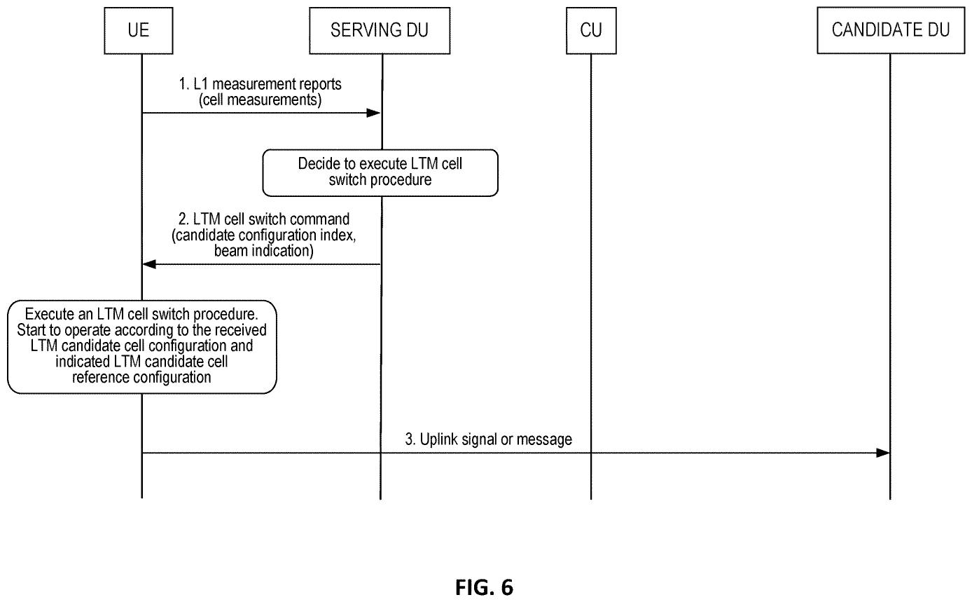

FIG. 6 is a signaling flow for an LTM switch procedure. In this example, the UE 30 has already executed LTM configuration and has stored at least one LTM candidate cell configuration and received an indication of an LTM candidate cell reference configuration.

In Step 1, the UE 30 performs L1 measurements on the configured LTM candidate cells and transmits L1 measurement reports including these measurements to the serving DU.

In Step 2, the serving DU 20D decides to trigger an LTM cell switch procedure to an LTM candidate cell. The serving DU 20D transmits, to the UE, an LTM cell switch command, including a candidate configuration index identifying the LTM candidate cell configuration, and a beam indication identifying a beam in the target cell.

In Step 3, the UE 30 receives the LTM cell switch command and executes the LTM cell switch procedure. During the execution, the UE 30 starts to operate according to the previously received (during LTM configuration) LTM candidate cell configuration indicated by the received candidate configuration index, and indication of an LTM candidate cell reference configuration.

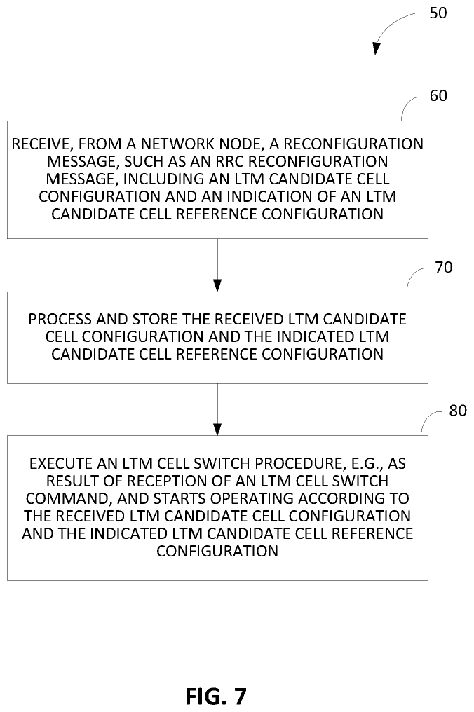

FIG. 7 illustrates an exemplary method 50 implemented by a UE. In this example, the LTM candidate cell configuration uses delta configuration on top of an existing LTM candidate cell reference configuration. The UE 30 receives, from a network node, a reconfiguration message, such as an RRCReconfiguration message, including an LTM candidate cell configuration and an indication of an LTM candidate cell reference configuration (block 60). The UE 30 processes and stores the received LTM candidate cell configuration and the indicated LTM candidate cell reference configuration (block 70). In some embodiments, the UE 30 transmits a reconfiguration response message, such as an RRCReconfigurationComplete message, to the network node, to confirm the reception of LTM candidate cell configuration and an indication of an LTM candidate cell reference configuration. The UE 30 executes an LTM cell switch procedure, e.g., as result of reception of an LTM cell switch command, and starts operating according to the received LTM candidate cell configuration and the indicated LTM candidate cell reference configuration (block 80). The UE 30 determines a target candidate configuration for the indicated target cell and switches to the target cell. In the target cell, the UE 30 uses the target candidate configuration to transit and/or receive user data and/or control data.

An example implementation into 3GPP TS 38.331 (RRC specification) is illustrated here. In this example, a new IE, LTM-Configuration, is specified, which may include an LTM candidate cell reference configuration, and a set of LTM candidate cell configurations, where each of these LTM candidate cell configurations includes an indication of an LTM candidate cell reference configuration. The IE LTM-Configuration may be included in an RRCReconfiguration message that is transmitted to the UE 30 when a network node initiates LTM configuration. In this example, an indication of reference configuration may be associated with a reference configuration, to indicate how the included reference configuration is to be processed by the UE.

LTM-Configuration information element

```
LTM-Configuration-r18 ::= SEQUENCE {
  ltm-CandidateCellReferenceConfiguration-r18 SEQUENCE {
  ltm-CandidateCellRefConfig-r18 OCTET STRING (CONTAINING RRCReconfiguration)
OPTIONAL,
  ltm-CandidateCellRefConfigIndex-r18 LTM-CandidateConfigurationIndex-r18,
  ltm-IndicationOfCandidateCellReferenceConfiguration-r18 LTM-
IndicationOfCandidateCellReferenceConfiguration-r18 OPTIONAL
  } OPTIONAL, -- Need M
  ltm-CandidateCellConfigurationToAddModList-r18 LTM-
```

| | |
|---|---|
| CandidateCellConfigurationToAddModList-r18 | OPTIONAL, -- Need |

N
ltm-CandidateCellConfigurationToReleaseList-r18 LTM-

| | |
|---|---|
| CandidateCellConfigurationToReleaseList-r18 | OPTIONAL, -- Need |

N
}
LTM-CandidateCellConfigurationToAddModList-r18 ::= SEQUENCE (1..maxNumOfLTM-
CandidateCellConfiguration-r18) OF LTM-CandidateCellConfigurationToAddMod-r18
LTM-CandidateCellConfigurationToAddMod-r18 ::= SEQUENCE {

| | |
|---|---|
| ltm-CandidateConfigurationIndex-r18 | LTM-CandidateConfigurationIndex -r18, |
| ltm-CandidateCellConfiguration-r18 | OCTET STRING (CONTAINING |

RRCReconfiguration),
ltm-IndicationOfCandidateCellReferenceConfiguration-r18 LTM-
IndicationOfCandidateCellReferenceConfiguration-r18
}
LTM-CandidateConfigurationIndex-r18 ::= INTEGER (1..maxNumOfLTM-
CandidateCellConfiguration-r18)
LTM-IndicationOfCandidateCellReferenceConfiguration-r18 ::= CHOICE {

| | |
|---|---|
| ltm-UseUEsCurrentConfiguration | NULL, |
| ltm-UseCandidateCellConfiguration | LTM-CandidateConfigurationIndex-r18, |
| ltm-UseDefaultReferenceConfiguration | NULL, |
| ltm-UseFullConfiguration | NULL, |
| ltm-DoNotUseReferenceConfiguration | NULL, |
| ltm-NoReferenceConfigurationAvailable | NULL, |
| ltm-ReplaceReferenceConfiguration | NULL, |
| ltm-ModifyReferenceConfiguration | NULL, |
| ltm-UseReferenceConfiguration | LTM-CandidateConfigurationIndex-r18 |

}

Implementation of exemplary embodiments into 3GPP TS 38.473 (F1AP specification), discussed below, requires modification of the UE 30 Context Setup and UE 30 Context Modification (gNB-CU initiated) is required.

The purpose of the UE 30 Context Setup procedure is to establish the UE 30 Context including, among others, SRB, DRB, BH RLC channel, Uu Relay RLC channel, PC5 Relay RLC channel, and SL DRB configuration. The procedure uses UE-associated signaling.

If the Configured Cells IE is included in the UE 30 Context Setup Request message the gNB-DU shall, if supported, consider that the configuration identified by the Configuration Index IE is generated for the cell identified by the Target Cell ID IE. If the Reference Configuration IE is included in the UE 30 Context Setup Request message, the gNB-DU shall, if supported, use it to generate the configuration for the cell and include the generated configuration in the UE 30 Context Setup Response message in the DU to CU RRC Information IE.

Table 1 below illustrates an exemplary format of the UE 30 Context Setup Request. This message is sent by the gNB-CU to the gNB-DU to request the setup of a UE 30 context.

TABLE 1
UE 30 Context Setup Request

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Configured Cells List | | 0 . . . 1 | | YES | ignore |
| >Configured Cells | | 1 . . . | | EACH | ignore |
| Item IEs | | <maxnoofL1/L2Cells> | | | |
| >>Target Cell ID | M | | NR CGI | — | |
| | | | 9.3.1.12 | | |
| >>Configuration | O | | FFS | YES | ignore |
| Index | | | | | |
| >>Reference | O | | 9.3.x.x | YES | ignore |
| Configuration | | | | | |

The purpose of the UE 30 Context Modification procedure is to modify the established UE 30 Context, e.g., establishing, modifying and releasing radio resources or sidelink resources. This procedure is also used to command the gNB-DU to stop data transmission for the UE 30 for mobility (see TS 38.401 ver. 17.3.0). The procedure uses UE-associated signaling.

If the Configured Cells IE is included in the UE 30 Context Modification Request message, the gNB-DU shall, if supported, consider that the configuration identified by the Configuration Index IE is generated for the cell identified by the Target Cell ID IE. If the Reference Configuration IE is included in the UE 30 Context Modification Request message the gNB-DU shall, if supported, use it to generate the configuration for the cell, and include the generated configuration in the UE 30 Context Modification Response message in the DU to CU RRC Information IE.

If the Current Configuration IE is included in the Configured Cells IE in the UE 30 Context Modification Request message, the gNB-DU shall, if supported, provide the current cell configuration in the UE 30 Context Modification Response message.

Table 2 below illustrates an exemplary format of the UE 30 Context Modification Request. This message is sent by the gNB-CU to the gNB-DU to provide UE 30 Context information changes to the gNB-DU.

TABLE 2
UE 30 Context Modification Request

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Configured Cells List | | 0 . . . 1 | | YES | ignore |
| >Configured Cells | | 1 . . . | | EACH | ignore |
| Item IEs | | <maxnoofL1/L2Cells> | | | |
| >>Target Cell ID | M | | NR CGI | — | |
| | | | 9.3.1.12 | | |
| >>Configuration | O | | FFS | YES | ignore |
| Index | | | | | |
| >>Reference | O | | 9.3.x.x | YES | ignore |
| Configuration | | | | | |
| >>Current | O | | 9.3.y.y | YES | ignore |
| Configuration | | | | | |

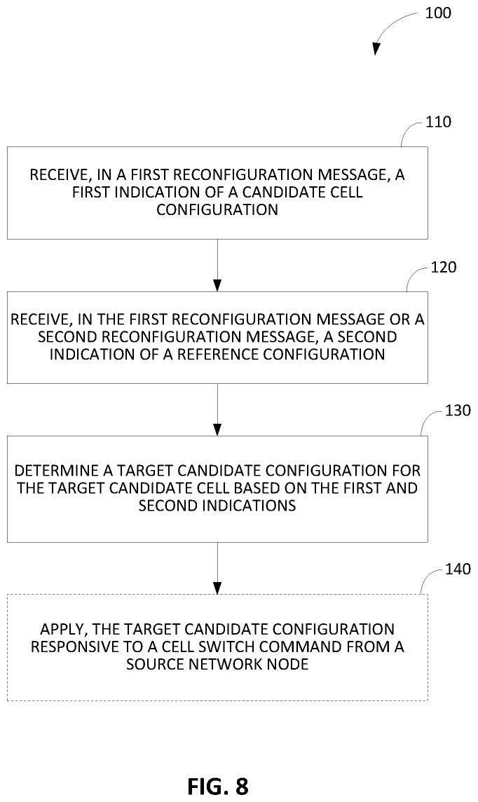

FIG. 8 illustrates a method 100 implemented by a UE. The UE 30 receives in a first reconfiguration message, a first indication of a candidate cell configuration (block 110). The UE 30 further receives, in the first reconfiguration message or a second reconfiguration message, a second indication of a reference configuration (block 120). The UE 30 determines a target candidate configuration for the candidate cell based on the first and second indications (block 130). In some embodiments, the UE 30 applies, the target candidate configuration responsive to a cell switch command from a source network node (e.g., base station or serving DU) (block 140). The phrase “responsive to a cell switch command” is used in its broadest sense and includes both an immediate cell switch and a cell switch upon fulfillment of a condition specified in the cell switch command. Thus, in some embodiments, the target candidate configuration is applied immediately when the cell switch command is received. In other embodiments, the target candidate configuration is applied when a condition specified by the cell switch command is met. In one sense, applying the target candidate configuration means that the UE 30 uses the target candidate configuration to transmit and/or receive user data and/or control data in the target cell.

In some embodiments of method 100, the second indication comprises an indication to use the current configuration of the UE 30 as the reference configuration. In one embodiment, the UE's current configuration comprises an RRC configuration the UE 30 has stored (and is operating accordingly) before the UE receives the indication to use the UE's current configuration. For example, assume that the UE 30 is operating according to an RRC configuration (t0), e.g., represented by a set of parameters in an RRCReconfiguration message at time (t0). Then the UE 30 receives from the network an RRC Reconfiguration message (RRCReconfiguration) including the indication to use the UE's current configuration as the reference configuration for LTM. In response, the UE 30 applies the received RRCReconfiguration message on top of its current configuration (denoted RRCReconfiguration (10)), resulting to a UE's configuration denoted RRCReconfiguration (t1). However, according to this embodiment, the UE's current configuration is considered as the reference configuration for LTM is the RRCReconfiguration (t0). One benefit of this option is that the source DU 20D and/or the CU 20C may provide to the candidate DU 20D the actual UE current configuration, so the candidate DU 20D generates the delta signaling for the LTM candidate cell configuration, to be applied by the UE 30 on top of the reference configuration (in this example the UE's current configuration).

In another example, the UE's current configuration comprises the RRC configuration the UE has as a result to the received RRC message including the indication to use the UE's current configuration.

For example, assume the UE 30 is operating according to an RRC configuration (t0) e.g. represented by a set of parameters in an RRCReconfiguration message, denoted RRCReconfiguration (t0). Then, the UE receives from the network an RRC Reconfiguration message (RRCReconfiguration) including the indication to use the UE's current configuration as the reference configuration. Then, the UE applies the received RRCReconfiguration message on top of its current configuration (denoted RRCReconfiguration (t0)), resulting to a UE's configuration denoted RRCReconfiguration (t1), which is considered the UE's current configuration).

In some embodiments of method 100, the second indication comprises an indication to use a default configuration of the UE 30 as the reference configuration.

In some embodiments of method 100, the second indication comprises an identification of one of a plurality of candidate cell configurations configured for the UE 30 to use as the reference configuration. In one example, this indication may be a field, flag, or IE within the LTM configuration for an LTM candidate cell configuration. For example, the UE 30 may be configured with a plurality of LTM candidate cell(s), each having an associated LTM candidate cell configuration and an LTM configuration ID, and at least one of these includes the field which indicates that to be the reference configuration, e.g., (LTM candidate cell configuration (a), ID=1), (LTM candidate cell configuration (b), ID=2, flag indicating that to be reference configuration). In that case, one option is that if that candidate (b) is executed, there is no need to apply the LTM candidate cell configuration (b) on top of the reference configuration, which is also the LTM cell configuration (b).

In some embodiments of method 100, the second indication comprises an identification of a candidate cell configuration received in a reconfiguration message different from the one containing the second indication.

In some embodiments of method 100, the second indication comprises an identification of a candidate cell configuration received in a same reconfiguration message as the second indication.

In some embodiments of method 100, the second indication comprises an indication of a reference configuration that is not part of any configured candidate cell configuration currently configured for the UE.

In some embodiments of method 100, the second indication comprises an identification of a partial reference configuration. That is, the reference configuration comprises part of a configuration, but not a full UE configuration. In one example, the reference configuration is a configuration that may include a plurality of fields, flags or IEs that may not be part of an LTM candidate cell configuration and nor the current UE configuration. This is the case on when the reference configuration allows the network to configure the UE with a set of fields, flags or IEs that are not part of an LTM candidate cell configuration but that still do not require the network to provide the UE with a full RRC message (e.g., all the fields included in an RRCReconfiguration message).

In some embodiments of method 100, the second indication comprises an identification of a delta configuration with respect to a previous reference configuration.

In some embodiments of method 100, the second indication comprises an indication not to use a reference configuration or an indication that no reference configuration is available. In one example, one or more LTM candidate cell configurations include the indication not to use a reference configuration. Thus, when the UE executes an LTM cell switch procedure to an LTM candidate cell for which the indication to not use a reference configuration has been configured, the UE applies the LTM candidate cell configuration on top of its current configuration, and/or assume the LTM candidate cell configuration is a full configuration and reconfigures it accordingly. In another example, the indication is a full configuration indication included in the LTM candidate cell configuration. For example, when the LTM candidate cell configuration is modeled as an RRCReconfiguration and that includes a full configuration indication (e.g. field/IE fullConfig in the RRCReconfiguration for the LTM candidate cell configuration). When the UE executes an LTM cell switch procedure to that cell, the UE does not rely on a reference configuration and perform a full configuration procedure, e.g., the UE performs the full configuration procedure, for example, as specified in section 5.3.5.11 of 3GPP TS 38.331. In another example, the indication is a full configuration that is included in the LTM cell switch command. This indication implies that the network node that generates the LTM candidate cell configuration needs to inform the source network node on whether an LTM candidate cell configuration is built according to a full configuration or a delta configuration.

In some embodiments of method 100, the second indication comprises an indication to replace a previous reference configuration with an indicated reference indication.

In some embodiments of method 100, the second indication comprises an indication to delete a previous reference configuration.

In some embodiments of method 100, the second indication comprises an indication to use the indicated candidate cell configuration as a full configuration.

In some embodiments of method 100, the second indication comprises an identification of a choice in a choice structure.

In some embodiments of method 100, the second indication comprises an identifier that uniquely identifies the reference configuration in a group of reference configurations. In one example, there are multiple reference configurations configured in the UE 30, and each of the reference configurations is associated with an identifier. The advantage with multiple reference configurations is in cases when the LTM candidate cell configurations are very different. One such case are cells in frequency range 1 (FR1) and cells in frequency range 2 (FR2).

In some embodiments of method 100, determining the target candidate configuration for the candidate cell based on the first and second indications comprises storing the indicated candidate cell configuration, and determining the target candidate configuration responsive to a cell switch command from a network node.

In some embodiments of method 100, determining a target candidate configuration for the candidate cell based on the first and second indications further comprises storing the second indication and determining the reference configuration based on the second indication responsive to the cell switch command.

In some embodiments of method 100, determining the target candidate configuration for the candidate cell based on the first and second indications further comprises storing the reference configuration.

In some embodiments of method 100, the candidate configuration comprises a delta configuration with respect to the reference configuration.

In some embodiments of method 100, the target candidate configuration responsive to the cell switch command comprises applying, depending on the second indication, changes indicated by the candidate configuration to the reference configuration to determine the full target candidate configuration.

In some embodiments of method 100, determining the target candidate configuration responsive to the cell switch command comprises using the indicated candidate configuration as the full target candidate configuration depending on the second indication.

In some embodiments of method 100, determining the target candidate configuration responsive to a cell switch command from a network node comprises performing, prior to the cell switch command, a first reconfiguration making changes to a current UE 30 configuration based on the reference configuration to determine a new UE 30 configuration, performing, responsive to the cell switch command, a second reconfiguration responsive to the cell switch command based on the candidate cell configuration to determine the target candidate configuration.

In some embodiments of method 100, determining the target candidate configuration responsive to a cell switch command from a network node comprises applying, responsive to the cell switch command, the reference configuration to a current UE 30 configuration to determine an intermediate UE 30 configuration, and applying the candidate cell configuration to the intermediate UE 30 configuration to determine the target candidate configuration.

In some embodiments of method 100, determining the target candidate configuration for the candidate cell based on the first and second indications comprises combining the candidate cell configuration and the reference configuration to predetermine the candidate cell configuration, and storing the predetermined candidate target configuration.

Some embodiments of method 100 further comprise sending an acknowledgement of the first reconfiguration message, the second reconfiguration message, or both.

Some embodiments of method 100 further comprise receiving a cell switch command and performing an immediate cell switch responsive to the cell switch command.

Some embodiments of method 100 further comprise receiving a conditional cell switch command indicating a condition, and performing a cell switch responsive to fulfillment of the condition.

In some embodiments of method 100, determining a target candidate configuration for the candidate cell based on the first and second indications comprises determining the target candidate configuration when the condition has been fulfilled.

In some embodiments of method 100, determining the target candidate configuration when the condition has been fulfilled comprises applying, responsive to the cell switch command, the reference configuration to a current UE 30 configuration to determine an intermediate UE 30 configuration, and applying, responsive to fulfillment of the condition, the candidate cell configuration to the intermediate UE 30 configuration to determine the target candidate configuration.

In some embodiments of method 100, determining the target candidate configuration when the condition has been fulfilled comprises:

Some embodiments of method 100 further comprise applying the target candidate configuration to communicate with the candidate cell following to a cell switch to the candidate cell.

Some embodiments of method 100 further comprise persisting the reference configuration following the switch to the candidate cell.

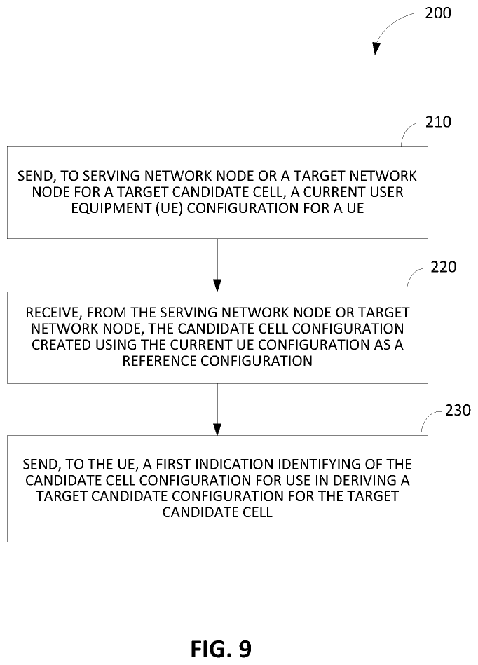

FIG. 9 illustrates a method 200 supporting LTM implemented by distributed DU for a source network node in a wireless communication network. The DU sends, to serving network node or a target network node for a candidate cell, a current user equipment (UE) configuration for a UE 30 (block 210). The DU receives, from the serving network node or target network node, the candidate cell configuration created using the current UE 30 configuration as a reference configuration (block 220). The DU sends, to the UE, a first indication identifying of the candidate cell configuration for use in deriving a target candidate configuration for the candidate cell (block 230).

Some embodiments of method 200 further comprise sending, to the UE, a second indication to use the current UE configuration as a reference configuration to derive the target candidate configuration.

Some embodiments of method 200 further comprise sending the first indication to the UE in a cell switch command to initiate a cell switch to the candidate cell.

In some embodiments of method 200, the first and/or second indication is contained in the cell switch command.

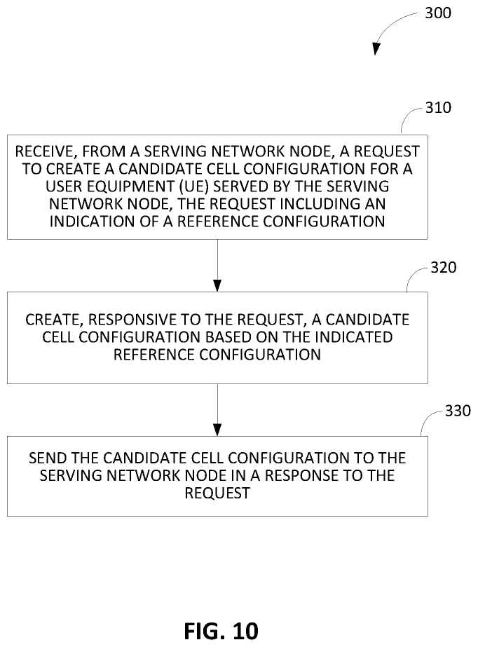

FIG. 10 illustrates a method 300 supporting LTM implemented by a target network node. The target network node receives, from a serving network node, a request to create a candidate cell configuration for a user equipment (UE) served by the serving network node (block 310). The request includes an indication of a reference configuration. The target network node creates, responsive to the request, a candidate cell configuration based on the indicated reference configuration (block 320). The target network node sends the candidate cell configuration to the serving network node in a response to the request (block 330).

In some embodiments of method 300, the indication of the reference configuration comprises at least one of: an indication to use the current configuration of the UE as the reference configuration; an indication to use a default configuration of the UE as the reference configuration; an identification of one of a plurality of candidate cell configurations configured for the UE to use as the reference configuration; an identification of a candidate cell configuration contained in reconfiguration message; an indication of a reference configuration that is not part of any configured candidate cell configuration configured for the UE; or an indication not to use a reference configuration.

In some embodiments of method 300, the candidate cell configuration sent in the response comprises a full configuration.

In some embodiments of method 300, the candidate cell configuration sent in the response comprises a delta configuration with respect to the reference configuration.

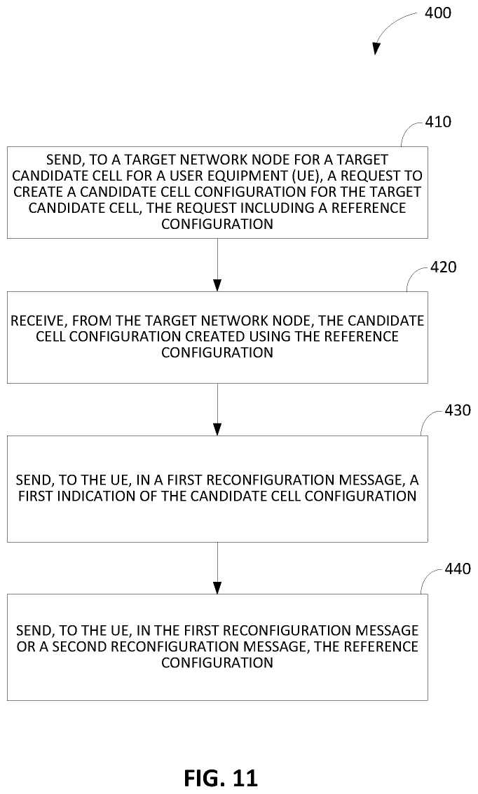

FIG. 11 illustrates a method 400 implemented by a serving network node. The serving network node sends, to a target network node for a candidate cell for a user equipment (UE), a request to create a candidate cell configuration for the candidate cell (block 410). The request including a reference configuration. The serving network node receives, from the target network node, the candidate cell configuration created using the reference configuration (block 420). The serving network node sends, to the UE, in a first reconfiguration message, a first indication of the candidate cell configuration (block 430). The serving network node sends, to the UE, in the first reconfiguration message or a second reconfiguration message, the reference configuration (block 440).

In some embodiments of method 400, the candidate cell configuration received from the target network node in the response comprises a full configuration.

In some embodiments of method 400, the candidate cell configuration from the target network node in the response comprises a delta configuration with respect to the reference configuration.

In some embodiments of method 400, the indication of the reference configuration comprises at least one of: an indication of the current configuration of the UE; an indication to use a default configuration of the UE as the reference configuration; an identification of one of a plurality of candidate cell configurations configured for the UE to use as the reference configuration; an identification of a candidate cell configuration contained in another reconfiguration message; an indication of a reference configuration that is not part of any configured candidate cell configuration configured for the UE; or an indication not to use a reference configuration.

Some embodiments of method 400 further comprise sending a request to the UE for the UE's current configuration and receiving the UE's current configuration from the UE responsive to the request to the UE.

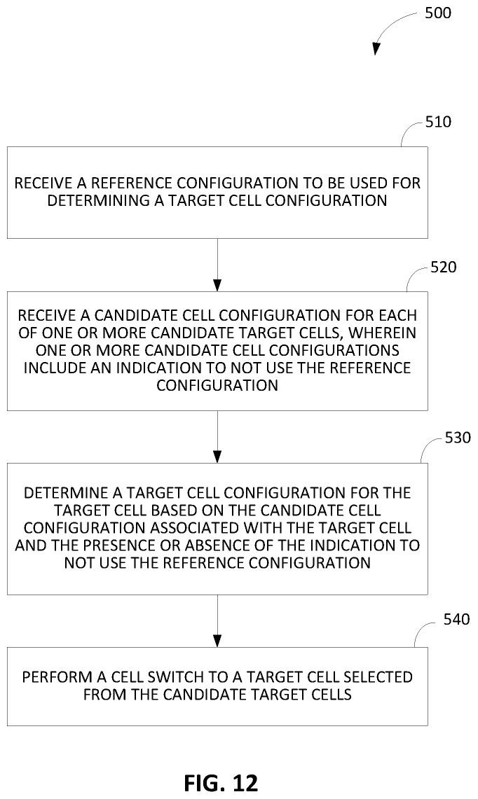

FIG. 12 illustrates a method 500 of L1/L2-based inter-cell mobility implement by a UE 30. The UE receives a reference configuration to be used for determining a target cell configuration (block 510). The UE 30 further receives a candidate cell configuration for each of one or more candidate cells (block 520). One or more candidate cell configurations include an indication to not use the reference configuration. The UE 30 determines a target cell configuration for the target cell based on the candidate cell configuration associated with the target cell and the presence or absence of the indication to not use the reference configuration (block 530). The UE 30 performs a cell switch to a target cell selected from the candidate cells (block 540).

In some embodiments of method 500, determining a target cell configuration for the target cell comprises applying the candidate cell configuration of the target cell to the reference configuration when the indication is absent.

In some embodiments of method 500, determining a target cell configuration for the target cell comprises applying the candidate cell configuration of the target cell to a current configuration and/or without using the reference configuration when the indication is present.

In some embodiments of method 500, determining a target cell configuration for the target cell comprises applying the candidate cell configuration of the target cell as a full configuration when the indication is present.

In some embodiments of method 500, receiving a reference configuration comprises receiving an indication to use the current configuration of the UE 30 as the reference configuration.

In some embodiments of method 500, receiving a reference configuration comprises receiving an indication to use a default configuration of the UE as the reference configuration.

In some embodiments of method 500, receiving a reference configuration comprises receiving an indication to use one of a plurality of candidate cell configurations configured for the UE 30 as the reference configuration.

In some embodiments of method 500, the indication of the reference configuration comprises an indication in the candidate cell configuration used as the reference configuration.

In some embodiments of method 500, receiving a reference configuration comprises receiving an identification of a candidate cell configuration received in a reconfiguration message as the candidate cell configuration used as the reference configuration.

In some embodiments of method 500, receiving a reference configuration comprises receiving an identification of a candidate cell configuration received in a same reconfiguration message as the candidate cell configuration used as the reference configuration.

In some embodiments of method 500, receiving a reference configuration comprises receiving an indication of a reference configuration that is not part of any configured candidate cell configuration currently configured for the UE 30.

In some embodiments of method 500, receiving a reference configuration comprises receiving an identification of a partial reference configuration.

In some embodiments of method 500, receiving a reference configuration comprises receiving an identification of a delta configuration with respect to a previous reference configuration.

In some embodiments of method 500, the indication of the reference configuration comprises receiving indication that no reference configuration is available.

In some embodiments of method 500, receiving a reference configuration comprises receiving an indication to replace a previous reference configuration with an indicated reference indication.

In some embodiments of method 500, receiving a reference configuration comprises receiving an indication to delete a previous reference configuration.

In some embodiments of method 500, receiving a reference configuration comprises receiving an indication to use the indicated candidate cell configuration as a full configuration.

In some embodiments of method 500, receiving a reference configuration comprises receiving comprises an identification of a choice in a choice structure.

In some embodiments of method 500, receiving a reference configuration comprises receiving an identifier that uniquely identifies the reference configuration in a group of reference configurations.

In some embodiments of method 500, determining the target cell configuration for the target cell comprises determining the target cell configuration responsive to a cell switch command from a network node.

In some embodiments of method 500, determining the target cell configuration responsive to the cell switch command comprises applying changes indicated by the candidate cell configuration for the target cell to the reference configuration to determine the target cell configuration.

In some embodiments of method 500, determining the target cell configuration for the candidate cell comprises predetermining the target cell configuration prior to reception of a cell switch command initiating the cell switch to the target cell.

In some embodiments of method 500, determining the target cell configuration for the candidate cell comprises applying the predetermined target cell configuration responsive to the reception of the cell switch command.

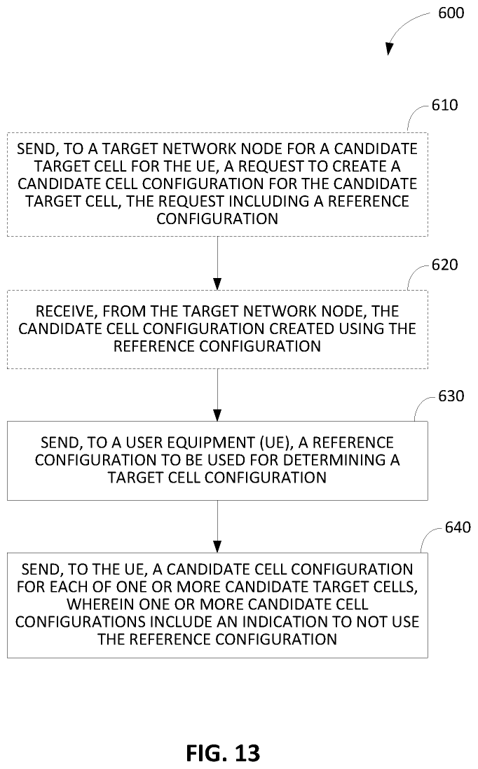

FIG. 13 illustrates a method 600 of L1/L2-based inter-cell mobility implemented by a network node (e.g. serving network node) in a wireless communication network. The network node optionally sends, to a target network node for a candidate cell for the UE 30, a request to create a candidate cell configuration for the candidate cell, the request including a reference configuration (block 610). The network node optionally receives, from the target network node, the candidate cell configuration created using the reference configuration (block 620). The network node sends, to a target network node for a candidate cell for the UE 30, a request to create a candidate cell configuration for the candidate cell, the request including a reference configuration (block 630). The network node sends, to the UE 30, a candidate cell configuration for each of one or more candidate cells, wherein one or more candidate cell configurations include an indication to not use the reference configuration (block 640).

In some embodiments of method 600, the candidate cell configuration received from the target network node in the response comprises a full configuration.

In some embodiments of method 600, the candidate cell configuration from the target network node in the response comprises a delta configuration with respect to the reference configuration.

In some embodiments of method 600, sending the reference configuration to the UE comprises sending at least one of:
an indication to use the current configuration of the UE 30 as the reference configuration;
an indication to use a default configuration of the UE 30 as the reference configuration;
an identification to use of one of a plurality of candidate cell configurations configured for the UE 30 to use as the reference configuration;
an identification to use of a candidate cell configuration contained in another reconfiguration message;
an indication to use of a reference configuration that is not part of any configured candidate cell configuration configured for the UE 30; or
an indication not to use a reference configuration.

Some embodiments of method 600 further comprise sending a request to the UE for the UE's current configuration, and receiving the UE's current configuration from the UE responsive to the request to the UE 30.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by one or more processors, carries out the techniques described herein.

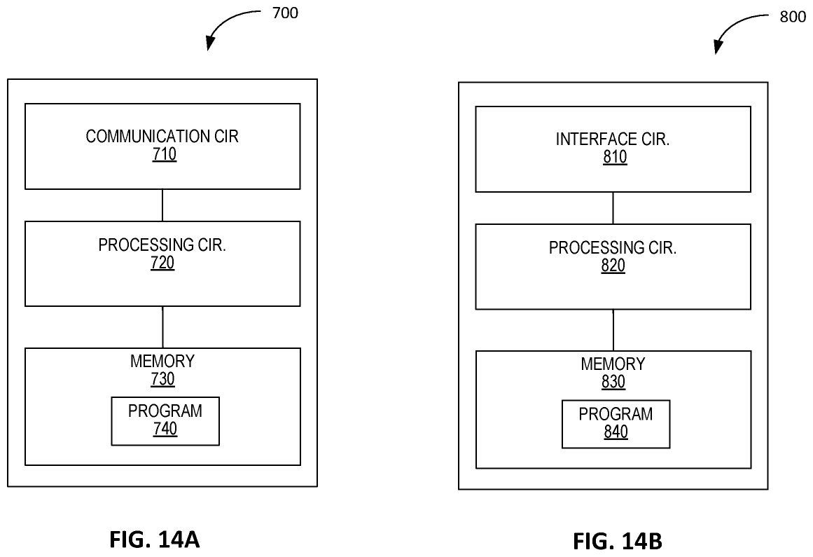

FIG. 14A illustrates an example an example UE 700 configured for inter-cell mobility using L1/L2 signaling. The UE 700 comprises communication circuitry 710, processing circuitry 720, and memory 730.

The communication circuitry 710 is coupled one or more antennas (not shown) and comprises the radio frequency (RF) circuitry needed for transmitting and receiving signals over a wireless communication channel. Processing circuitry 720 controls the overall operation of the UE 700 and processes the signals transmitted to or received by the UE 700. Processing circuitry 720 may comprise one or more microprocessors, hardware, firmware, or a combination thereof. The processing circuitry 720 in one embodiment is configured to perform the methods herein described including the method 100 of FIG. 8 and method 500 of FIG. 12.

Memory 730 comprises both volatile and non-volatile memory for storing computer program code and data needed by the processing circuit 720 for operation. Memory 730 may comprise any tangible, non-transitory computer-readable storage medium for storing data including electronic, magnetic, optical, electromagnetic, or semiconductor data storage. Memory 730 stores a computer program 240 comprising executable instructions that configure the processing circuitry 720 to implement the methods herein described including the method 100 according to FIG. 8 and method 500 according to FIG. 12. A computer program 740 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 240 for configuring the processing circuit 720 as herein described may be stored in a removable memory, such as a portable compact disc, portable digital video disc, or other removable media. The computer program 740 may also be embodied in a carrier such as an electronic signal, optical signal, radio signal, or computer readable storage medium.

FIG. 14B illustrates an example an example network node 800 in a wireless communication network configured to support inter-cell mobility using L1/L2 signaling. The network node 800 may comprise a source network node (e.g., source DU), a target network node (target DU), or serving network node (e.g., CU). The serving network node 800 may serve both the source network node and target network node. Alternatively the source network node and target network node can be served by different serving network node 800. The network node 800 comprises interface communication circuitry 810, processing circuitry 820, and memory 830.

The interface circuitry 810 comprises a network interface for communicating over a wireless communication channel with other network nodes. The processing circuitry 820 controls the overall operation of the serving network node 800. The processing circuit 820 may comprise one or more microprocessors, hardware, firmware, or a combination thereof. The processing circuitry 820 in one embodiment is configured to perform the methods herein described, including one or more of the methods 200, 300, and 400 shown in FIGS. 9-11 respectively and method 600 shown in FIG. 13.

Memory 830 comprises both volatile and non-volatile memory for storing computer program code and data needed by the processing circuit 820 for operation. Memory 830 may comprise any tangible, non-transitory computer-readable storage medium for storing data including electronic, magnetic, optical, electromagnetic, or semiconductor data storage. Memory 830 stores a computer program 840 comprising executable instructions that configure the processing circuit 230 to implement the perform the methods herein described, including one or more of the methods 200, 300, and 400 shown in FIGS. 9-11, respectively, and method 600 shown in FIG. 13. A computer program 840 in this regard may comprise one or more code modules corresponding to the means or units described above. In general, computer program instructions and configuration information are stored in a non-volatile memory, such as a ROM, erasable programmable read only memory (EPROM) or flash memory.

Temporary data generated during operation may be stored in a volatile memory, such as a random access memory (RAM). In some embodiments, computer program 840 for configuring the processing circuit 820 as herein described may be stored in a removable memory, such as a portable compact disc, portable digital video disc, or other removable media. The computer program 840 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

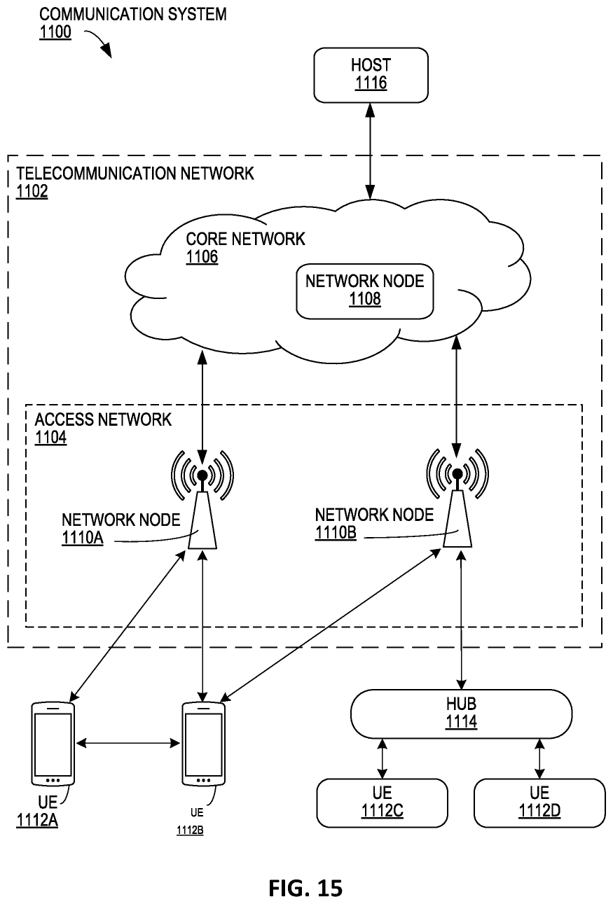

FIG. 15 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110A and 1110B (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112C and/or 1112D) and network nodes (e.g., network node 1110B). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110B. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

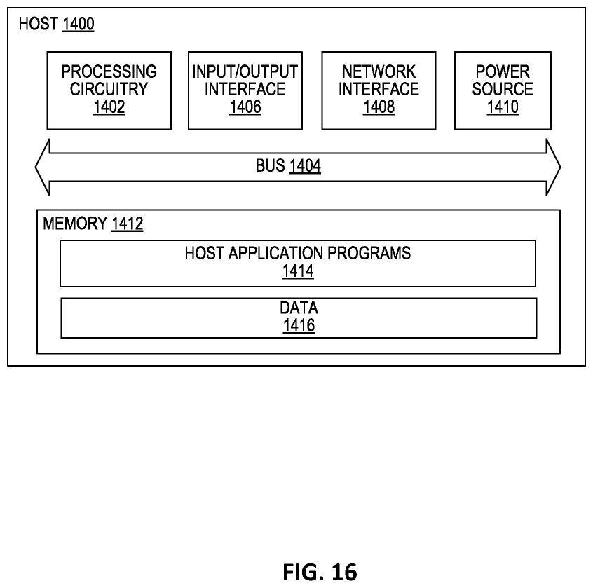

FIG. 16 is a block diagram of a host 1400, which may be an embodiment of the host 1116 of FIG. 15, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

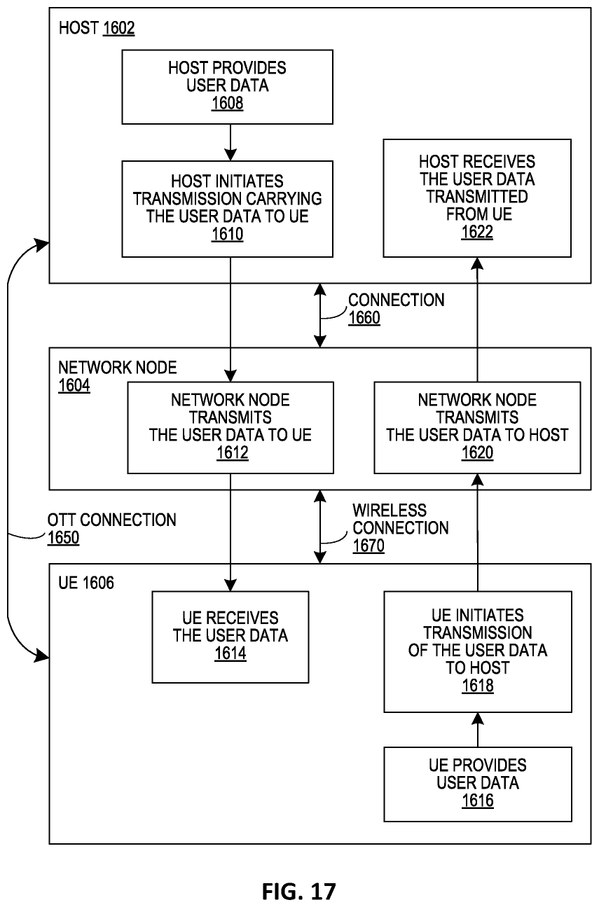

FIG. 17 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 15), network node (such as network node 1110a of FIG. 15), and host (such as host 1116 of FIG. 15) discussed in the preceding paragraphs will now be described with reference to FIG. 17.

Like host 1400 in FIG. 16, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 15) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve the latency following a cell change by the UE. In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

1.-34. (canceled)

35. A method performed by a user equipment (UE) in a wireless communication network that supports layer-1/layer-2 based inter-cell mobility (LTM), the method comprising
receiving a first indication of a reference configuration for target cells;
receiving respective candidate cell configurations for one or more candidate cells, wherein one or more of the candidate cell configurations include a second indication not to use the reference configuration;
determining a target cell configuration for a target cell, which is one of the candidate cells, based on the candidate cell configuration associated with the target cell and the presence or absence, in the candidate cell configuration, of the second indication not to use the reference configuration; and
performing a cell switch to a target cell selected from the candidate cells.

36. The method of claim 35, wherein determining the target cell configuration for the target cell based on the presence or absence of the second indication comprises, when the second indication is absent, applying the candidate cell configuration associated with the target cell to the reference configuration.

37. The method of claim 35, wherein determining a target cell configuration for the target cell based on the presence or absence of the second indication comprises, when the second indication is present, applying the candidate cell configuration associated with the target cell according to one or more of the following: to a current configuration, and without using the reference configuration.

38. The method of claim 35, wherein determining a target cell configuration for the target cell based on the presence or absence of the second indication comprises, when the second indication is present, applying the candidate cell configuration of the target cell as a full configuration.

39. The method of claim 35, wherein the first indication is of a reference configuration that is not part of any configured candidate cell configuration currently configured for the UE.

40. The method of claim 35, wherein the first indication indicates that no reference configuration is available.

41. The method of claim 35, wherein the first indication further indicates to replace a previous reference configuration with the indicated reference configuration.

42. The method of claim 35, wherein the first indication indicates to delete a previous reference configuration.

43. The method of claim 35, wherein the first indication further indicates to use the indicated reference configuration as a full configuration.

44. The method of claim 35, wherein:
the target cell configuration is determined responsive to a cell switch command from a network node; and
determining the target cell configuration comprises applying changes indicated by the candidate cell configuration associated with the target cell to the reference configuration to obtain the target cell configuration.

45. User equipment (UE) configured to operate in a wireless communication network that supports layer-1/layer-2 based inter-cell mobility (LTM), the UE comprising processing circuitry and communication circuitry that are operably coupled and configured to:
receive a first indication of a reference configuration for target cells;
receive respective candidate cell configurations for one or more candidate cells, wherein one or more of the candidate cell configurations include a second indication not to use the reference configuration;
determine a target cell configuration for a target cell, which is one of the candidate cells, based on the candidate cell configuration associated with the target cell and the presence or absence, in the candidate cell configuration, of the second indication not to use the reference configuration; and
perform a cell switch to a target cell selected from the candidate cells.

46. The UE of claim 45, wherein the processing circuitry and the communication circuitry are configured to determine the target cell configuration for the target cell based on the presence or absence of the second indication according to one or more of the following:
when the second indication is absent, applying the candidate cell configuration associated with the target cell to the reference configuration; and
when the second indication is present, applying the candidate cell configuration associated with the target cell according to one or more of the following: to a current configuration, and without using the reference configuration.

47. The UE of claim 45, wherein the processing circuitry and the communication circuitry are configured to determine the target cell configuration for the target cell based on the presence or absence of the second indication by, when the second indication is present, applying the candidate cell configuration of the target cell as a full configuration.

48. The UE of claim 45, wherein the first indication indicates one of the following:
a reference configuration that is not part of any configured candidate cell configuration currently configured for the UE;
that no reference configuration is available;
to replace a previous reference configuration with the indicated reference configuration;
to delete a previous reference configuration; or
to use the indicated reference configuration as a full configuration.

49. A method performed by a network node of a wireless communication network that supports layer-1/layer-2 based inter-cell mobility (LTM), the method comprising:
sending, to a user equipment (UE), a first indication of a reference configuration for target cells; and
sending, to the UE, respective candidate cell configurations for one or more candidate cells, wherein one or more of the candidate cell configurations include a second indication not to use the reference configuration.

50. The method of claim 49, further comprising:
sending, to a second network node, a request to create a candidate cell configuration for a candidate cell provided by the second network node, wherein the request includes the reference configuration; and
receiving, from the second network node, the candidate cell configuration which is based on the reference configuration.

51. The method of claim 49, wherein the candidate cell configuration received from the second network node comprises one of the following: a full configuration, or a delta configuration with respect to the reference configuration.

52. The method of claim 48, wherein the first indication indicates at least one of the following:
to use the UE's current configuration as the reference configuration;
to use a default configuration of the UE as the reference configuration;
to use of one of a plurality of candidate cell configurations configured for the UE as the reference configuration;
to use of a candidate cell configuration included in another message;
to use a reference configuration that is not part of any candidate cell configuration configured for the UE; and
not to use a reference configuration.

53. The method of claim 48, further comprising:
sending a request to the UE for the UE's current configuration; and
receiving the UE's current configuration from the UE responsive to the request.

54. A network node configured to operate in a wireless communication network that supports layer-1/layer-2 based inter-cell mobility (LTM), the network node comprising processing circuitry and communication circuitry that are operably coupled and configured to perform the method of claim 49.
